(19) United States
(12) Patent Application Publication
(10) Pub. No.: US 2016/0375855 A1
(43) Pub. Date: Dec. 29, 2016

(54) Cantilevered Windshield Support For Pedestrian Protection

(71) Applicant: Ford Global Technologies, LLC, Dearborn, MI (US)

(72) Inventor: Henry W. Hausler, Manchester, MI (US)

(21) Appl. No.: 14/753,283

(22) Filed: Jun. 29, 2015

(51) Int. Cl. B60R 21/34; B62D 25/08; B60J 1/00

(52) U.S. Cl. CPC B60R 21/34; B60J 1/005; B62D 25/081; B60R 2021/346

(57) ABSTRACT

A vehicle including a vehicle frame and a cowl box assembly. The cowl box assembly has a cowl box and a cowl top panel, A cantilevered support extends from a rear edge of the cowl top panel to a lower edge of a windshield. The cantilevered support resiliently attaches to a front/lower edge of the windshield. The cowl top panel extends from a front end of the cowl box to a back end of the cowl box. The cantilevered support is attached to the back end of the cowl top panel to extend above the cowl top panel to the lower edge of the windshield that is disposed forward of the front end of the cowl box. The cantilevered support deflects to a greater extent than the cowl box if an impact force is applied to the windshield in a collision with a pedestrian.

### TECHNICAL FIELD

This disclosure relates to a cowl structure and resilient windshield support that reduces the force applied by the windshield to a pedestrian in a vehicle collision with a pedestrian.

### BACKGROUND

Structural boxed cowl structures are part of a vehicle frame that supports the rear edge of the hood, the windshield, dashboard and instrument panel.

Pedestrian protection standards must be met that are intended to reduce the risk of injury and extent of any injuries to a pedestrian in a vehicle/pedestrian collision. One proposed solution is to provide a cowl that is made entirely of a soft resilient polymer. However, this approach causes structural loads to be applied to less efficient supporting structures and reduces torsional strength and adversely impacts performance of the cowl.

This disclosure is directed to the above problems and other problems as summarized below.

### SUMMARY

According to one aspect of this disclosure, a vehicle is provided that includes a vehicle frame including a cowl box and a cowl top panel and a cantilevered support that extends from a rear edge of the cowl top panel to a lower edge of a windshield. The support resiliently attaches to a front/lower edge of the windshield. The cowl box and cowl top panel are more rigid than the support.

According to other aspects of this disclosure, the cowl top panel may extend from a front end of the cowl box to a back end of the cowl box. The support may be attached to the back end of the cowl top panel above the cowl top panel to the lower edge of the windshield that is disposed forward of the front end of the cowl box. The cantilevered support deflects to a greater extent than the cowl box when an impact is applied to the windshield, for example, in a collision with a pedestrian.

The vehicle may further comprise a pair of braces attached to the cowl box and wherein each brace extends to one of a pair of shock towers. The vehicle may further comprise a pair of shotgun rails and the cowl box may extend between and may be attached to the shotgun rails to tie the shotgun rails together to increase the torsional strength of the vehicle frame.

According to another aspect of this disclosure a front end assembly is disclosed that includes a pair of frame rails extending longitudinally, a pair of shotgun rails attached to the frame rails and a pair of shock tower braces attached to a pair of shock towers. A cowl box is attached between the shotgun rails and extends in a transverse vehicle direction. A cowl top panel is attached to the cowl box that includes a windshield support attached to a rear edge of the cowl top panel and cowl box. The windshield extends to a front/lower edge of the windshield. The front/lower edge of the windshield support is disposed in a location above and forward of the cowl box.

According to other aspects of this disclosure, the windshield support resiliently supports the windshield above the cowl box and cowl top panel that are fabricated from metal or plastic materials that are more rigid than the windshield support.

According to another aspect of this disclosure a method of assembling a vehicle is disclosed that comprises the following steps:

assembling a cowl box to a frame of the vehicle and the dashboard;

assembling a cowl top panel to a cantilevered support as a sub-assembly;

assembling the sub-assembly to the cowl box; and

attaching a lower edge of the windshield to the cantilevered support.

According to other aspects of the method, the step of assembling the sub-assembly to the cowl box may further comprise welding the cowl top panel to the cowl box with the cantilevered support attached to the cowl top panel as part of the sub-assembly. The welding step may be performed in a framer tool.

The above aspects and other aspects of this disclosure are described in greater detail below with reference to the attached drawings.

### BRIEF DESCRIPTION OF THE DRAWINGS

FIG. 1 is a front/side perspective view of a vehicle that includes a cowl structure made according to one aspect of this disclosure

FIG. 2 is a fragmentary perspective view of part of a vehicle frame including the cowl structure.

FIG. 3 is a fragmentary perspective view of the cowl including a soft cowl top attached to a windshield and a dash panel.

FIG. 4 is a cross-sectional view taken along the line 4-4 in FIG. 1.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

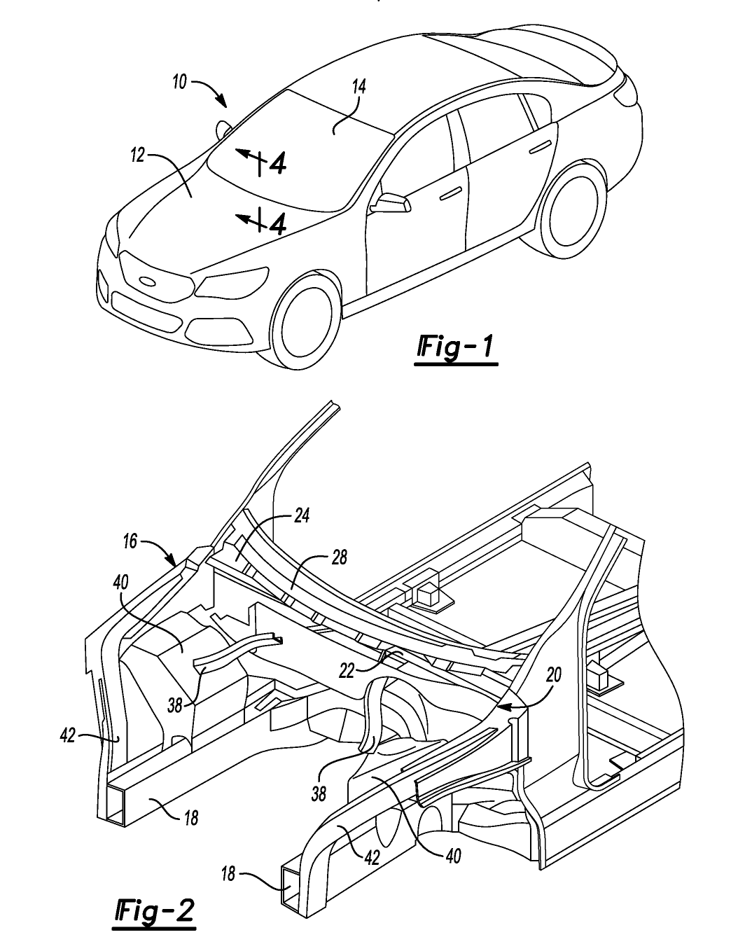

Referring to FIG. 1, a vehicle 10 is shown to include a hood 12 and a windshield 14.

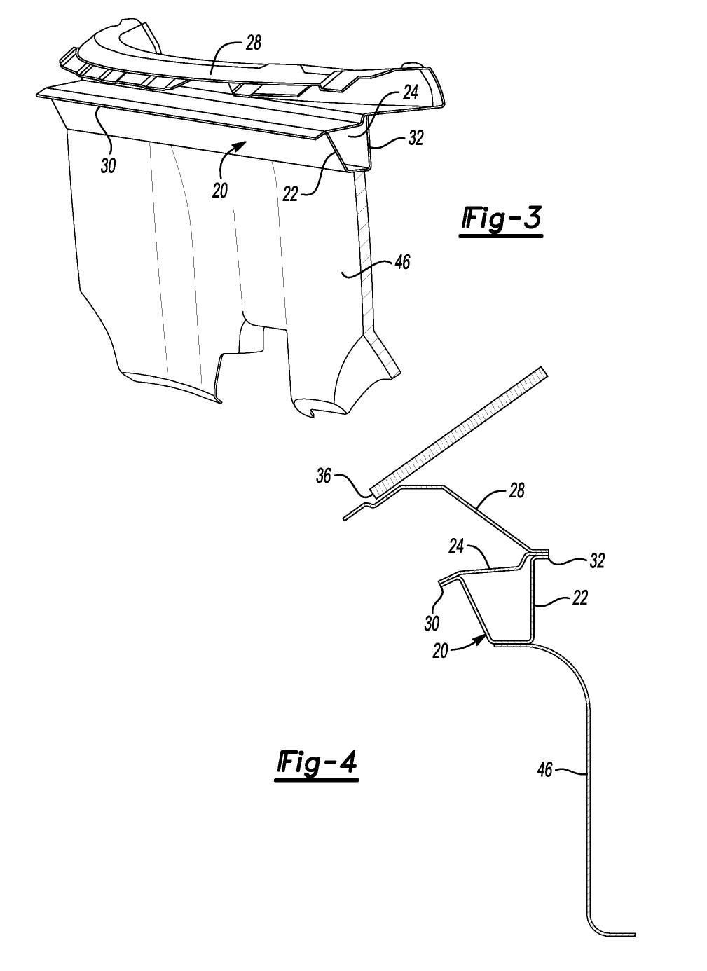

Referring to FIG. 2, a front end assembly 16 of the vehicle 10 is illustrated that is built on a pair of frame rails 18 that extend longitudinally in the fore-and-aft vehicle direction. A cowl assembly 20 is provided as part of the front end assembly 16 of the vehicle 10. The cowl assembly 20 includes a cowl box 22 and a cowl top panel 24. The cowl top panel 24 is welded to the cowl box 22 to provide a rigid cross car support that improves the torsional stiffness of the front end assembly 16. A windshield support 28, or cantilevered support, is attached to the cowl assembly 20. The cowl assembly 20 and windshield support 28 are more clearly illustrated in FIGS. 3 and 4.

Referring to FIGS. 3 and 4, the cowl box 22 includes a front end 30 and a back end 32. The cowl top panel 24 is attached to the front edge 30 and the back edge 32 of the cowl box 22 by welding. The windshield support 28 is attached to the back end 32 of the cowl top panel 24 that is, in turn, attached to the cowl box 22. The windshield support 28 is cantilevered from the back end 32 of the cowl assembly 20 and extends to a front/lower edge 36 of the windshield 14.

Referring back to FIG. 2, braces 38 are assembled to the cowl assembly 20 and extend to the shock towers 40 on right and left sides of the vehicle 10. A pair of shotgun rails 42 extends from the cowl assembly 20 to the frame rails 18. The cowl assembly 20 is welded to the shotgun rails 42 on opposite lateral sides of the cowl assembly 20. The cowl assembly 20 is assembled to the shotgun rails 42. The cowl assembly 20 extends in a transverse vehicle direction between the shotgun rails. The cowl assembly 20 increases the torsional stiffness of the front end assembly 16. By increasing the torsional strength of the front end assembly 16, the front end assembly is expected to improve the performance of the vehicle in offset crash tests, small offset rigid barrier tests (SORB), and may also increase roof strength.

Referring to FIGS. 3 and 4, a dash panel 46 is shown in relation to the cowl assembly 20. The cowl assembly 20 is disposed above the dash panel 46 and ties together the shotgun rails 42 and the windshield 14.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A vehicle comprising:
a vehicle frame including a cowl box and a cowl top panel; and
a cantilevered support that extends from a back end of the cowl top panel to a lower edge of a windshield, wherein the support resiliently attaches to a front/lower edge of the windshield, and wherein the cowl box and cowl top panel are more rigid than the support.

2. The vehicle of claim 1 wherein the cowl top panel extends from a front end of the cowl box to a back end of the cowl box.

3. The vehicle of claim 1 wherein the support is attached to the back end of the cowl top panel above the cowl top panel to the windshield, wherein the lower edge of the windshield is disposed forward of a front end of the cowl box.

4. The vehicle of claim 1 further comprising:
a pair of braces attached to the cowl box and wherein each brace extends to one of a pair of shock towers.

5. The vehicle of claim 1 further comprising:
a pair of shotgun rails, wherein the cowl box extends between and is attached to the pair of shotgun rails to tie the shotgun rails together to increase the torsional strength of the vehicle frame.

6. The vehicle of claim 1 wherein the cantilevered support deflects to a greater extent than the cowl box when an impact is applied to the windshield.

7. A front end assembly for a vehicle comprising:
a pair of frame rails extending longitudinally;
a pair of shotgun rails attached to the frame rails;
a pair of shock tower braces attached to a pair of shock towers;
a cowl box attached between the pair of shotgun rails and extending in a transverse direction; and
a cowl top panel attached to the cowl box and including a windshield support attached to a rear edge of the cowl top panel and cowl box and extending to a front/lower edge of the windshield that is disposed in a location above and forward of the cowl box.

8. The front end assembly of claim 7 wherein the windshield support provides for resilient attachment of the windshield, and wherein the cowl box and cowl top panel are more rigid than the windshield support.

9. The front end assembly of claim 7 wherein the cowl top panel extends from a front end of the cowl box to the back end of the cowl box.

10. The front end assembly of claim 7 wherein pair of shock tower braces are attached to the cowl box to increase the torsional strength of the front end assembly.

11. The front end assembly of claim 7 wherein the cowl box extends between and is attached to the pair of shotgun rails to connect the pair of shotgun rails together to increase the torsional strength of the front end assembly.

12. The front end assembly of claim 7 wherein the cantilevered support deflects to a greater extent than the cowl box when an impact is applied to the windshield.

13. A method of assembling part of a vehicle comprising:
assembling a cowl box to a frame of the vehicle and a dashboard;
assembling a cowl top panel to a cantilevered support as a sub-assembly;
assembling the sub-assembly to the cowl box; and
attaching a lower edge of a windshield to the cantilevered support.

14. The method of claim 13 wherein the step of assembling the sub-assembly to the cowl box further comprises:
welding the cowl top panel to the cowl box with the cantilevered support attached as part of the sub-assembly.

15. The method of claim 14 wherein the welding step is performed in a framer tool.
